(19) United States
(12) Patent Application Publication
(10) Pub. No.: US 2024/0020143 A1
(43) Pub. Date: Jan. 18, 2024

(54) SELECTING A PRIMARY TASK EXECUTOR FOR HORIZONTALLY SCALED SERVICES

(71) Applicant: VMware, Inc., Palo Alto, CA (US)

(72) Inventors: Miroslav SHTARBEV, Sofia (BG); Tanya TOSHEVA, Sofia (BG); Desislava NIKOLOVA, Sofia (BG); Petko CHOLAKOV, Sofia (BG)

(21) Appl. No.: 17/867,262

(22) Filed: Jul. 18, 2022

(51) Int. Cl. G06F 9/455

(52) U.S. Cl. CPC G06F 9/45558; G06F 2009/4557

(57) ABSTRACT

An example method of selecting a primary instance of a horizontally scaled service executing in a public cloud, comprising: querying, by a first instance of a plurality of instances of the horizontally scaled service, a database for a value of an identifier of a primary instance, the primary instance configured to perform an exclusive task, each of the plurality of instances other than the primary instance configured to defer the exclusive task to the primary instance; setting, by the first instance, the value of the identifier of the primary instance to a first identifier of the first instance in response to the value of the identifier of the primary instance being unset in the database; and updating data associated with the identifier of the primary instance in the database, by the first instance while performing the exclusive task, to the exclusion of each other instance of the plurality of instances.

### BACKGROUND

In a software-defined data center (SDDC), virtual infrastructure, which includes virtual compute, storage, and networking resources, is provisioned from hardware infrastructure that includes a plurality of host computers, storage devices, and networking devices. The provisioning of the virtual infrastructure is carried out by management software that communicates with virtualization software (e.g., hypervisor) installed in the host computers.

SDDC users move through various business cycles, requiring them to expand and contract SDDC resources to meet business needs. This leads users to employ multi-cloud solutions, such as typical hybrid cloud solutions where the SDDC spans across an on-premises data center and a public cloud. Running applications across multiple clouds can engender complexity in setup, management, and operations. Further, there is a need for centralized control and management of applications across the different clouds. One such complexity is product enablement. The traditional licensing model where users obtain license keys for different application deployments can become burdensome in multi-cloud environments. Users should be able to move workloads between clouds seamlessly while minimizing licensing costs. Users desire to pay for what they use regardless of deployment.

### SUMMARY

In an embodiment, a method of selecting a primary instance of a horizontally scaled service executing in a public cloud is described. The method includes: querying, by a first instance of a plurality of instances of the horizontally scaled service, a database for a value of an identifier of a primary instance, the primary instance configured to perform an exclusive task, each of the plurality of instances other than the primary instance configured to defer the exclusive task to the primary instance; setting, by the first instance, the value of the identifier of the primary instance to a first identifier of the first instance in response to the value of the identifier of the primary instance being unset in the database; and updating data associated with the identifier of the primary instance in the database, by the first instance while performing the exclusive task, to the exclusion of each other instance of the plurality of instances.

Further embodiments include a non-transitory computer-readable storage medium comprising instructions that cause a computer system to carry out the above method, as well as a computer system configured to carry out the above method.

### BRIEF DESCRIPTION OF THE DRAWINGS

FIG. 1 depicts a cloud control plane implemented in a public cloud and an SDDC that is managed through the cloud control plane, according to embodiments.

FIG. 2 is a block diagram of an SDDC in which embodiments described herein may be implemented.

FIG. 3 is a block diagram depicting a keyless entitlement environment according to embodiments.

FIG. 4 is a flow diagram depicting a method of obtaining and reporting subscription usage according to an embodiment.

FIG. 5 is a flow diagram depicting a method of subscribing to software in a multi-cloud system according to embodiments.

FIG. 6 is a flow diagram depicting a method of applying a subscription entitlement according to embodiments.

FIG. 7 is a flow diagram depicting a method of selecting a primary task executor for a horizontally scaled service according to an embodiment.

### DETAILED DESCRIPTION

Techniques for selecting a primary task executor for horizontally scaled services are described. In embodiments, a multi-cloud computing system includes a public cloud in communication with one or more data centers through a message fabric. The public cloud includes cloud services executing therein that are configured to interact with endpoint software executing in the data centers. In embodiments, the cloud services, establish connections with the endpoint software using an agent platform appliance executing in the data center. The agent platform appliance and the cloud services communicate through the messaging fabric, as opposed to a virtual private network (VPN) or similar private connection. In embodiments, some cloud services are horizontally scaled. A horizontally scaled cloud service includes a plurality of instances executing concurrently. In some cases, a load balancer can balance requests to the cloud service across its plurality of instances. A horizontally scaled cloud service can perform tasks in response to input requests and can track the status of these tasks as they are being performed. The horizontally scaled service can track the status of tasks in a database. However, multiple instances of the cloud service concurrently tracking task status in the database can lead to data corruption and incorrect status reports. Techniques are described herein that select a primary instance of a cloud service for performing exclusive functions, such as tracking task status. A primary instance is an instance of a service that is tasked with performing one or more exclusive functions. Those instances other than the primary instance (non-primary or secondary instances) do not perform the functions exclusive to the primary instance. The secondary instances are configured to defer performance of the exclusive tasks to the primary instance. These and further embodiments are described below with respect to the drawings.

One or more embodiments employ a cloud control plane for managing the configuration of SDDCs, which may be of different types and which may be deployed across different geographical regions, according to a desired state of the SDDC defined in a declarative document referred to herein as a desired state document. The cloud control plane is responsible for generating the desired state and specifying configuration operations to be carried out in the SDDCs according to the desired state. Thereafter, configuration agents running locally in the SDDCs establish cloud inbound connections with the cloud control plane to acquire the desired state and the configuration operations to be carried out, and delegate the execution of these configuration operations to services running in a local SDDC control plane.

One or more embodiments provide a cloud platform from which various services, referred to herein as “cloud services” are delivered to the SDDCs through agents of the cloud services that are running in an appliance (referred to herein as an “agent platform appliance”). A cloud platform hosts containers and/or virtual machines (VMs) in which software components can execute, including cloud services and other services and databases as described herein. Cloud services are services provided from a public cloud to endpoint software executing in data centers such as the SDDCs. The agent platform appliance is deployed in the same customer environment, e.g., a private data center, as the management appliances of the SDDCs. In one embodiment, the cloud platform is provisioned in a public cloud and the agent platform appliance is provisioned as a virtual machine in the customer environment, and the two communicate over a public network, such as the Internet. In addition, the agent platform appliance and the management appliances communicate with each other over a private physical network, e.g., a local area network. Examples of cloud services that are delivered include an SDDC configuration service, an SDDC upgrade service, an SDDC monitoring service, an SDDC inventory service, and a message broker service. Each of these cloud services has a corresponding agent deployed on the agent platform appliance. All communication between the cloud services and the endpoint software of the SDDCs is carried out through the agent platform appliance using a messaging fabric, for example, through respective agents of the cloud services that are deployed on the agent platform appliance. The messaging fabric is software that exchanges messages between the cloud platform and agents in the agent platform appliance over the public network. The components of the messaging fabric are described below.

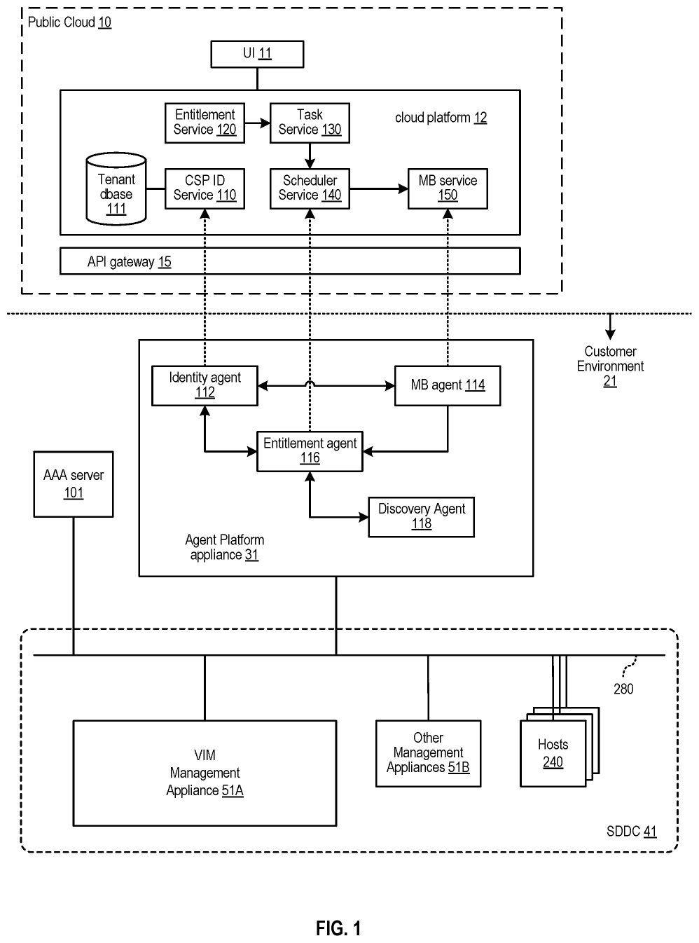

FIG. 1 is a block diagram of customer environments of different organizations (hereinafter also referred to as “customers” or “tenants”) that are managed through a multi-tenant cloud platform 12, which is implemented in a public cloud 10. A user interface (UI) or an application programming interface (API) that interacts with cloud platform 12 is depicted in FIG. 1 1 as UI 11.

An SDDC is depicted in FIG. 1 in a customer environment 21 and is a data center in communication with public cloud 10. In the customer environment, the SDDC is managed by respective virtual infrastructure management (VIM) appliances, e.g., VMware vCenter® server appliance and VMware NSX® server appliance. The VIM appliances in each customer environment communicate with an agent platform appliance, which hosts agents that communicate with cloud platform 12, e.g., via a messaging fabric over a public network, to deliver cloud services to the corresponding customer environment. For example, the VIM appliances 51 for managing the SDDCs in customer environment 21 communicate with agent platform appliance 31. VIM appliances 51 are an example of endpoint software executing in a data center that is a target of a cloud service executing in public cloud 10. Endpoint software is software executing in the data center with which a cloud service can interact as described further herein.

As used herein, a “customer environment” means one or more private data centers managed by the customer, which is commonly referred to as “on-prem,” a private cloud managed by the customer, a public cloud managed for the customer by another organization, or any combination of these. In addition, the SDDCs of any one customer may be deployed in a hybrid manner, e.g., on-premise, in a public cloud, or as a service, and across different geographical regions.

In the embodiments, the agent platform appliance and the management appliances are a VMs instantiated on one or more physical host computers (not shown in FIG. 1) having a conventional hardware platform that includes one or more CPUs, system memory (e.g., static and/or dynamic random access memory), one or more network interface controllers, and a storage interface such as a host bus adapter for connection to a storage area network and/or a local storage device, such as a hard disk drive or a solid state drive. In some embodiments, the gateway appliance and the management appliances may be implemented as physical host computers having the conventional hardware platform described above.

One or more embodiments provide a cloud platform from which various services, referred to herein as “cloud services” are delivered to the SDDCs through agents of the cloud services that are running in an appliance (referred to herein as an “agent platform appliance”). The cloud platform is a computing platform that hosts containers or virtual machines corresponding to the cloud services that are delivered from the cloud platform. The agent platform appliance is deployed in the same customer environment, e.g., a private data center, as the management appliances of the SDDCs. In one embodiment, the cloud platform is provisioned in a public cloud and the agent platform appliance is provisioned as a virtual machine in the customer environment, and the two communicate over a public network, such as the Internet. In addition, the agent platform appliance and the management appliances communicate with each other over a private physical network, e.g., a local area network. Examples of cloud services that are delivered include an SDDC configuration service, an SDDC upgrade service, an SDDC monitoring service, an SDDC inventory service, and a message broker service. Each of these cloud services has a corresponding agent deployed on the agent platform appliance. All communication between the cloud services and the management software of the SDDCs is carried out through the agent platform appliance, for example, through respective agents of the cloud services that are deployed on the agent platform appliance.

FIG. 1 illustrates components of cloud platform 12 and agent platform appliance 31. The components of cloud platform 12 include a number of different cloud services that enable each of a plurality of tenants that have registered with cloud platform 12 to manage its SDDCs through cloud platform 12. During registration for each tenant, the tenant's profile information, such as the URLs of the management appliances of its SDDCs and the URL of the tenant's AAA (authentication, authorization and accounting) server 101, is collected, and user IDs and passwords for accessing (i.e., logging into) cloud platform 12 through UI 11 are set up for the tenant. The user IDs and passwords are associated with various users of the tenant's organization who are assigned different roles. The tenant profile information is stored in tenant dbase 111, and login credentials for the tenants are managed according to conventional techniques, e.g., Active Directory® or LDAP (Lightweight Directory Access Protocol).

In one embodiment, each of the cloud services is a microservice that is implemented as one or more container images executed on a virtual infrastructure of public cloud 10. The cloud services include a cloud service provider (CSP) ID service 110, an entitlement service 120, a task service 130, a scheduler service 140, and a message broker (MB) service 150. Similarly, each of the agents deployed in the Agent platform appliances is a microservice that is implemented as one or more container images executing in the gateway appliances.

CSP ID service 110 manages authentication of access to cloud platform 12 through UI 11 or through an API call made to one of the cloud services via API gateway 15. Access through UI 11 is authenticated if login credentials entered by the user are valid. API calls made to the cloud services via API gateway 15 are authenticated if they contain CSP access tokens issued by CSP ID service 110. Such CSP access tokens are issued by CSP ID service 110 in response to a request from identity agent 112 if the request contains valid credentials.

In the embodiment, entitlement service 120 executes as a cloud service of cloud platform 12 that interacts with endpoint software in a data center to apply subscription entitlement(s) to the endpoint software. A subscription entitlement enables a feature or features of the endpoint software each providing some functionality. Without a subscription entitlement, the corresponding feature and its functionality is disabled in the endpoint software. The entitlement service 120 generates commands that are hereinafter referred to as “entitlement commands.” In response to an entitlement command, entitlement service 120 creates a task corresponding to the entitlement command and makes an API call to task service 130 to perform the task (“entitlement task”). Task service 130 then schedules the task to be performed with scheduler service 140, which then creates a message containing the task to be performed and inserts the message in a message queue managed by MB service 150. After scheduling the task to be performed with scheduler service 140, task service 130 periodically polls scheduler service 140 for status of the scheduled task.

At predetermined time intervals, MB agent 114, which is deployed in agent platform appliance 31, makes an API call to MB service 150 to exchange messages that are queued in their respective queues (not shown), i.e., to transmit to MB service 150 messages MB agent 114 has in its queue and to receive from MB service 150 messages MB service 150 has in its queue. MB service 150 implements a messaging fabric on behalf of cloud platform 12 over which messages are exchanged between cloud platform (e.g., cloud services 120) and agent platform appliance 31 (e.g., cloud agents 116). Agent platform appliance 31 can register with cloud platform 12 by executing MB agent 114 in communication with MB service 150. In the embodiment, messages from MB service 150 are routed to entitlement agent 116 if the messages contain entitlement tasks. Entitlement agent 116 thereafter issues a command to a management appliance that is targeted in the entitlement task (e.g., by invoking APIs of the management appliance) to perform the entitlement task and to check on the status of the entitlement task performed by the management appliance. When the task is completed by the management appliance, entitlement agent 116 invokes an API of scheduler service 140 to report the completion of the task.

Discovery agent 118 communicates with the management appliances of SDDC 41 to obtain authentication tokens for accessing the management appliances. In the embodiments, entitlement agent 116 acquires the authentication token for accessing the management appliance from discovery agent 118 prior to issuing commands to the management appliance, and includes the authentication token in any commands issued to the management appliance.

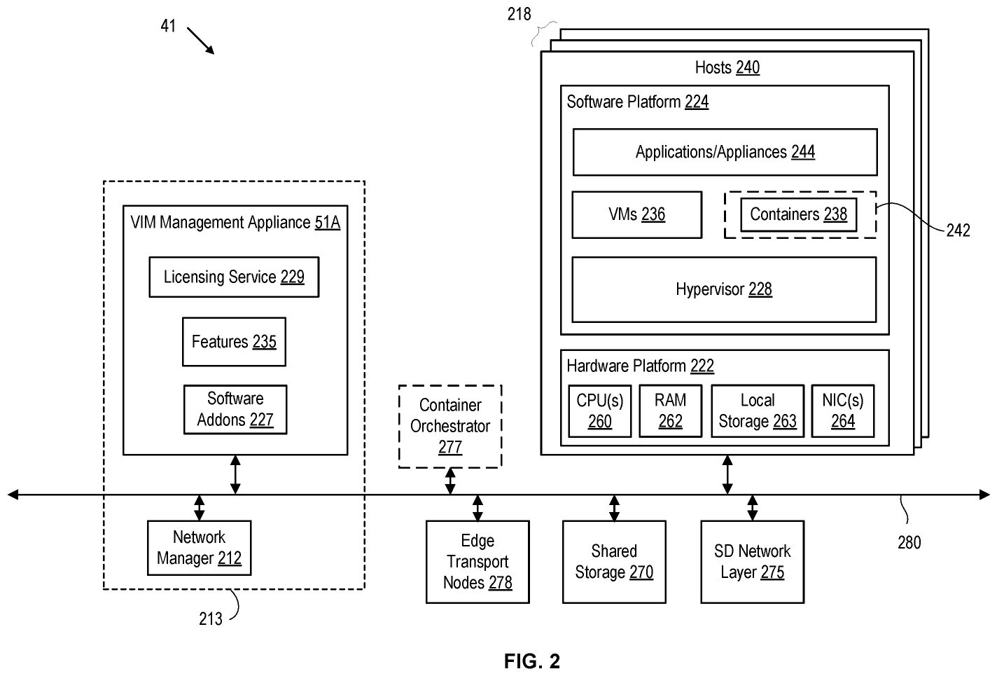

FIG. 2 is a block diagram of SDDC 41 in which embodiments described herein may be implemented. SDDC 41 includes a cluster of hosts 240 (“host cluster 218”) that may be constructed on hardware platforms such as an x86 architecture platforms. For purposes of clarity, only one host cluster 218 is shown. However, SDDC 41 can include many of such host clusters 218. As shown, a hardware platform 222 of each host 240 includes conventional components of a computing device, such as one or more central processing units (CPUs) 260, system memory (e.g., random access memory (RAM) 262), one or more network interface controllers (NICs) 264, and optionally local storage 263. CPUs 260 are configured to execute instructions, for example, executable instructions that perform one or more operations described herein, which may be stored in RAM 262. NICs 264 enable host 240 to communicate with other devices through a physical network 280. Physical network 280 enables communication between hosts 240 and between other components and hosts 240 (other components discussed further herein).

In the embodiment illustrated in FIG. 2, hosts 240 access shared storage 270 by using NICs 264 to connect to network 280. In another embodiment, each host 240 contains a host bus adapter (HBA) through which input/output operations (IOs) are sent to shared storage 270 over a separate network (e.g., a fibre channel (FC) network). Shared storage 270 include one or more storage arrays, such as a storage area network (SAN), network attached storage (NAS), or the like. Shared storage 270 may comprise magnetic disks, solid-state disks, flash memory, and the like as well as combinations thereof. In some embodiments, hosts 240 include local storage 263 (e.g., hard disk drives, solid-state drives, etc.). Local storage 263 in each host 240 can be aggregated and provisioned as part of a virtual SAN, which is another form of shared storage 270.

A software platform 224 of each host 240 provides a virtualization layer, referred to herein as a hypervisor 228, which directly executes on hardware platform 222. In an embodiment, there is no intervening software, such as a host operating system (OS), between hypervisor 228 and hardware platform 222. Thus, hyper-visor 228 is a Type-1 hypervisor (also known as a “bare-metal” hypervisor). As a result, the virtualization layer in host cluster 218 (collectively hypervisors 228) is a bare-metal virtualization layer executing directly on host hardware platforms. Hypervisor 228 abstracts processor, memory, storage, and network resources of hardware platform 222 to provide a virtual machine execution space within which multiple virtual machines (VM) 236 may be concurrently instantiated and executed. Applications and/or appliances 244 execute in VMs 236 and/or containers 238 (discussed below).

Host cluster 218 is configured with a software-defined (SD) network layer 275. SD network layer 275 includes logical network services executing on virtualized infrastructure in host cluster 218. The virtualized infrastructure that supports the logical network services includes hypervisor-based components, such as resource pools, distributed switches, distributed switch port groups and uplinks, etc., as well as VM-based components, such as router control VMs, load balancer VMs, edge service VMs, etc. Logical network services include logical switches and logical routers, as well as logical firewalls, logical virtual private networks (VPNs), logical load balancers and the like, implemented on top of the virtualized infrastructure. In embodiments, SDDC 41 includes edge transport nodes 278 that provide an interface of host cluster 218 to a wide area network (WAN) (e.g., a corporate network, the public Internet, etc.).

VIM management appliance 51A (also referred to as a VIM appliance) is a physical or virtual server that manages host cluster 218 and the virtualization layer therein. VIM management appliance 51A installs agent(s) in hypervisor 228 to add a host 240 as a managed entity. VIM management appliance 51A logically groups hosts 240 into host cluster 218 to provide cluster-level functions to hosts 240 such as VM migration between hosts 240 (e.g., for load balancing), distributed power management, dynamic VM placement according to affinity and anti-affinity rules, and high-availability. The number of hosts 240 in host cluster 218 may be one or many. VIM management appliance 51A can manage more than one host cluster 218.

In an embodiment, SDDC 41 further includes a network manager 212. Network manager 212 (another management appliance 51B) is a physical or virtual server that orchestrates SD network layer 275. In an embodiment, network manager 212 comprises one or more virtual servers deployed as VMs. Network manager 212 installs additional agents in hypervisor 228 to add a host 240 as a managed entity, referred to as a transport node. In this manner, host cluster 218 can be a cluster of transport nodes. One example of an SD networking platform that can be configured and used in embodiments described herein as network manager 212 and SD network layer 275 is a VMware NSX® platform made commercially available by VMware, Inc. of Palo Alto, CA.

VIM management appliance 51A and network manager 212 comprise a virtual infrastructure (VI) control plane 213 of SDDC 41. VIM management appliance 51A can include various VI services. The VI services include various virtualization management services, such as a distributed resource scheduler (DRS), high-availability (HA) service, single sign-on (SSO) service, virtualization management daemon, and the like. An SSO service, for example, can include a security token service, administration server, directory service, identity management service, and the like configured to implement an SSO platform for authenticating users.

In embodiments, SDDC 401 can include a container orchestrator 277. Container orchestrator 277 implements an orchestration control plane, such as Kubernetes®, to deploy and manage applications or services thereof on host cluster 218 using containers 238. In embodiments, hypervisor 228 can support containers 238 executing directly thereon. In other embodiments, containers 238 are deployed in VMs 236 or in specialized VMs referred to as “pod VMs 242.” A pod VM 242 is a VM that includes a kernel and container engine that supports execution of containers, as well as an agent (referred to as a pod VM agent) that cooperates with a controller executing in hypervisor 228 (referred to as a pod VM controller). Container orchestrator 277 can include one or more master servers configured to command and configure pod VM controllers in host cluster 218. Master server(s) can be physical computers attached to network 280 or VMs 236 in host cluster 218.

VIM management appliance 51A includes a licensing service 229, features 235, and optionally software addons 227. A user can be entitled to turn on one or more features 235 of VIM management appliance 51A. Features 235 include various functionalities, which can be part of different entitlement levels. For example, a lower entitlement level can include less enabled features 235 than a higher entitlement level. In embodiments, VIM management appliance 51A includes one or more software addons 227. A user can be entitled to install and execute software addons 227. Licensing service 229 receives entitlement information from cloud platform 12 and enables/disables features 235 and software addons 227 according to the entitlement information. Techniques for generating and providing the entitlement information are described below. In this manner licensing service 229 provides for “keyless licensing” by receiving entitlement information from cloud platform 12 and applying the entitlement information to VIM management appliance 51A. A user is not required to apply a software license key to VIM management appliance 51A through its user interface. Rather, as described further below, the user cooperates with cloud platform 12 to subscribe to various SDDC features, which can include VIM management appliance 51A and a corresponding set of features 235 and software addons 227 (if any). While embodiments are described herein with respect to VIM management appliance 51A, the keyless licensing techniques can be used with other VI control plane software, such as network manager 212 or the like.

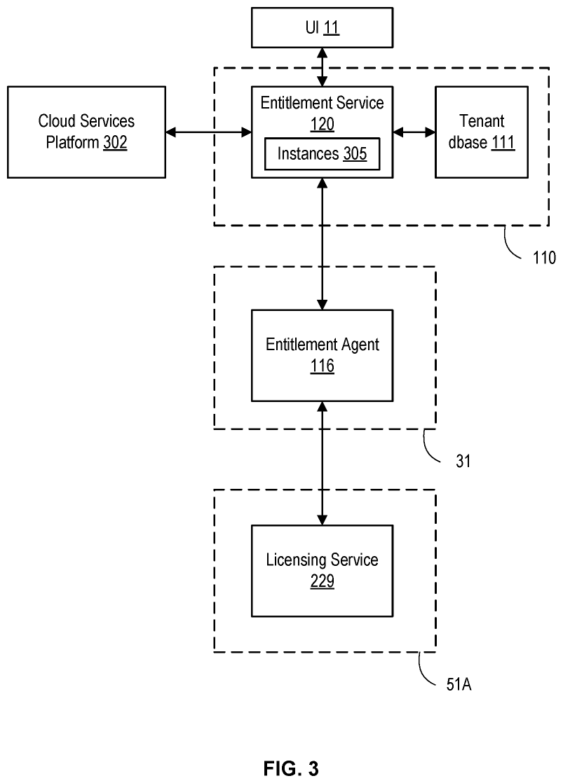

FIG. 3 is a block diagram depicting a keyless entitlement environment according to embodiments. Entitlement service 120 can communicate with tenant dbase 111 for storing and retrieving data. Entitlement service 120 also cooperates with a cloud services platform 302, which can be part of public cloud 10. A user interacts with cloud services platform 302 to subscribe to various SDDC features, services, and/or infrastructure, including the infrastructure/services on which cloud platform 12 executes. In embodiments, a user can also subscribe to features, services, and/or infrastructure in an SDDC 41. In the example above, a user can subscribe to VIM management appliance 51A and its corresponding features and software addons.

Entitlement service 120 communicates with entitlement agent 116 in SDDC 41. In embodiments, entitlement agent 116 can be part of agent platform appliance 31. Entitlement agent 116 communicates with various services in SDDC 41, including licensing service 229 in VIM management appliance 51A (or any other appliance being entitled using the keyless entitlement techniques described herein).

In embodiments, entitlement service 120 includes multiple executing instances 305. Each instance 305 is capable of performing the functionality of entitlement service 120. For example, entitlement service 120 can be a microservice managed by an orchestration system, such as Kubernetes®. The microservice can be configured with replication to provide a plurality of separate instances. Requests are then load-balanced across instances 305.

In embodiments, described below, instances 305 are capable of tracking progress of tasks for entitlement. For example, a user can request entitlement of one or more VIM server appliances and entitlement service 120 can execute one or more tasks to perform the entitlement. Entitlement service 120 tracks the progress of the task(s) and can report the progress to the user. In embodiments, entitlement service 120 tracks task progress in dbase 165. For example, a task can include multiple sub-tasks and the progress of each one can be tracked in dbase 111. Tracking task progress with multiple instances 305 can lead to data corruption, race conditions, and the like. As such, in embodiments, one of instances 305 becomes a primary instance while the remaining instances become secondary instances. The primary instance is an instance of the service that performs one or more exclusive tasks that are not performed by any other instance of the service. Each secondary instance is configured to defer the exclusive tasks to the primary instance. To avoid race conditions, only the primary instance tracks progress of the task in dbase 111. Techniques for selecting and maintaining a primary task executor for a horizontally scaled service (such as entitlement service 120) are described below.

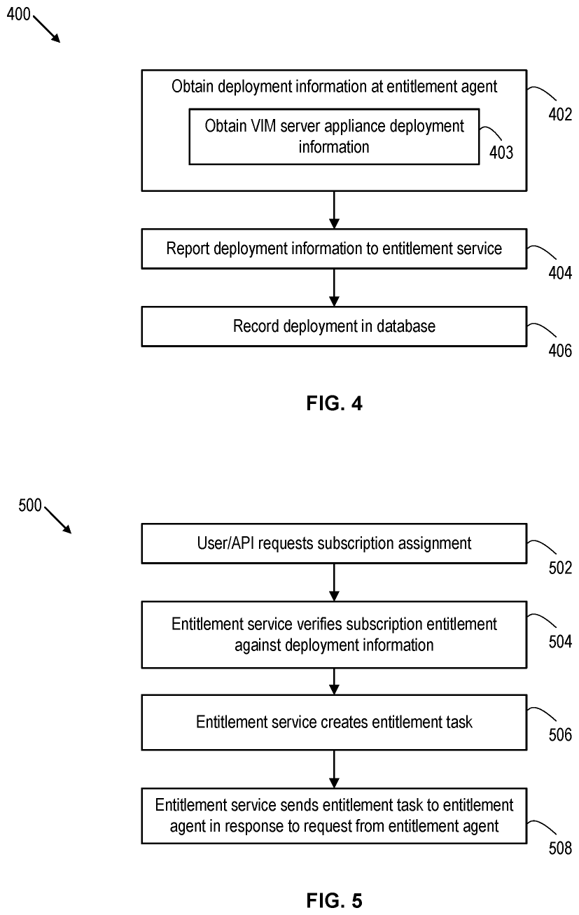

FIG. 4 is a flow diagram depicting a method 400 of obtaining and reporting subscription usage according to an embodiment. Method 400 begins at step 402, where entitlement agent 116 obtains deployment information from the appliances it monitors (e.g., VIM management appliance 51A). Deployment information is information describing the current deployments of the appliances (e.g., appliance versions, available features, available add-ons). For example, at step 403, entitlement agent 116 obtains VIM server appliance deployment information from VIM management appliance 51A. The deployment information can include, for example, software version information, identification information, feature information, software addon information, and the like. At step 404, entitlement agent 116 reports the deployment information to entitlement service 120. At step 406, entitlement service 120 records the deployment information for SDDC 41 obtained from entitlement agent 116 in tenant dbase 111. In embodiments, entitlement agent 116 can periodically perform method 400 to keep the deployment information up to date. In embodiments, entitlement agent 116 can perform method 400 on-demand, e.g., as requested by entitlement service 120.

FIG. 5 is a flow diagram depicting a method 500 of subscribing to software in a multi-cloud system according to embodiments. Method 500 begins at step 502, where a user or an API requests a subscription entitlement. For example, a user can subscribe to VIM management appliance 51A, including various features and/or addon software. The user can cooperate with cloud services platform 302 to subscribe to various SDDC features as described above. The user can then interact with UI 11 to request a subscription entitlement to applied based on the subscription. Alternatively, software can request the subscription entitlement be applied automatically based on the user's subscription. In another alternative, a user can request subscription entitlement in a state document for SDDC, in which case software can request the subscription entitlement to be applied.

At step 504, entitlement service 120 verifies the subscription entitlement against the deployment information. That is, entitlement service 120 verifies that the user has a subscription that authorizes the requested entitlement and verifies that SDDC 41 includes the deployment for the subscription. For example, if the requested entitlement is for VIM management appliance 51A, entitlement service 120 verifies that VIM management appliance 51A has been deployed, has the necessary version, software features, addon software, and the like to satisfy the requested entitlement. At step 506, entitlement service 120 creates an entitlement task (assuming there is a subscription and there is a deployment that can accept the subscription). At step 508, entitlement service 120 sends the entitlement task to entitlement agent 116 in response to a request by entitlement agent 116. Entitlement agent 116 polls for tasks from entitlement service 120.

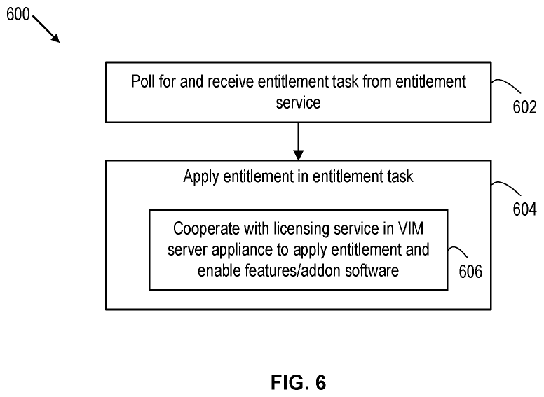

FIG. 6 is a flow diagram depicting a method 600 of applying a subscription entitlement according to embodiments. Method 600 begins at step 602, where entitlement agent 116 polls for and receives an entitlement task from entitlement service 120. At step 604, entitlement agent applies the subscription entitlement in the entitlement task. For example, at step 606, entitlement agent cooperates with licensing service 229 in VIM management appliance 51A to apply the subscription entitlement and enable features and/or software addons per the subscription entitlement.

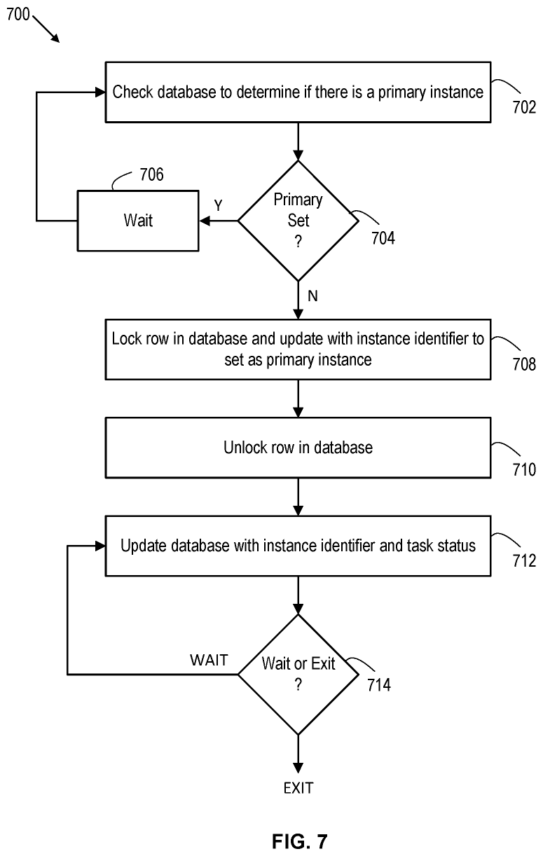

FIG. 7 is a flow diagram depicting a method 700 of selecting a primary task executor for a horizontally scaled service according to an embodiment. In the example, the horizontally scaled service is described as entitlement service 120 having instances 305. Those skilled in the art will appreciate that method 700 can be applied to other types of horizontally scaled services in cloud computing systems. Method 700 is performed by each instance 305 of entitlement service 120.

Method 700 begins at step 702, where instance 305 queries dbase 111 to determine if there is a primary instance. In embodiments, each instance 305 has an identifier. If an instance is set as a primary instance, its identifier is recorded in dbase 111 to indicate it is the primary instance. As discussed above, the primary instance of a horizontally scaled service is configured to perform exclusive task(s) that are not performed by secondary instance(s) of the service. In the embodiment where the service is the entitlement service, the exclusive task comprises tracking status of a task sent by the service to endpoint software in the data center (e.g., an entitlement task). At step 704, if there is a primary instance, method 700 proceeds to step 706. At step 706, instance 305 waits a threshold time period before returning to step 702 and rechecking if there is a primary instance. If at step 704 there is no primary instance, method 700 proceeds to step 708.

At step 708, instance 305 obtains a lock in dbase 111 and updates dbase 111 with its identifier. That is, instance 305 sets the value of the identifier for the primary instance in dbase 111 to its identifier in response to the value of the primary identifier in dbase 111 being unset (as determined in step 704). In such case, instance 305 becomes the primary instance. At step 710, instance 305 releases the lock. At step 712, instance 305 updates dbase 111 with the task status (e.g., status of the entitlement task). The task status updates can be associated with the instance identifier (e.g., in the same database row). Instance 305, being the primary instance, updates data associated with the identifier in dbase 111 to the exclusion of each other instance of the horizontally scaled service. At step 714, instance 305 waits a threshold time period and returns to step 712 or exits (e.g., gracefully due to termination of entitlement task 120 or abnormally).

In embodiments, dbase 111 is configured such that the instance identifier setting the primary instance is removed if not updated after a threshold period of time. As such, if the primary instance exits and no longer updates dbase 111 within the threshold time period, a secondary instance can discover that there is no primary instance selected. The, the secondary task will perform steps 708 and 710 to set itself as the primary instance and continue with updating the task status.

Techniques for selecting a primary task executor for horizontally scaled services are described. The primary task executor comprises a primary instance of a plurality of instances of a horizontally scaled service. Instances of the service other than the primary instance are secondary instances. The primary instance is configured to perform exclusive task(s) for the service. The secondary instance(s) defer the exclusive task(s) to the primary instance. In embodiments, the horizontally scaled service comprises an entitlement service executing in a public cloud. The entitlement service is configured to interact with endpoint software executing in a data center for the purpose to applying subscription entitlement(s) to the endpoint software. The entitlement service establishes a connection with the endpoint software by exchanging messages with an agent gateway appliance in the data center over a messaging fabric. Applying subscription entitlement(s) in the endpoint software comprises a task being performed by the entitlement service and can be executed by any instance thereof. Tracking status of the entitlement task comprises an exclusive task that is performed only by the primary instance of the entitlement service. Tracking task progress with multiple instances can lead to data corruption, race conditions, and the like. As such, the exclusive task of tracking status is delegated to the primary instance to avoid data corruption and race conditions. Those skilled in the art will appreciate that there are other types of exclusive tasks that would suffer from similar data corruption and race conditions if performed by multiple instances.

One or more embodiments of the invention also relate to a device or an apparatus for performing these operations. The apparatus may be specially constructed for required purposes, or the apparatus may be a general-purpose computer selectively activated or configured by a computer program stored in the computer. Various general-purpose machines may be used with computer programs written in accordance with the teachings herein, or it may be more convenient to construct a more specialized apparatus to perform the required operations.

The embodiments described herein may be practiced with other computer system configurations including hand-held devices, microprocessor systems, microprocessor-based or programmable consumer electronics, minicomputers, mainframe computers, etc.

One or more embodiments of the present invention may be implemented as one or more computer programs or as one or more computer program modules embodied in computer readable media. The term computer readable medium refers to any data storage device that can store data which can thereafter be input to a computer system. Computer readable media may be based on any existing or subsequently developed technology that embodies computer programs in a manner that enables a computer to read the programs. Examples of computer readable media are hard drives, NAS systems, read-only memory (ROM), RAM, compact disks (CDs), digital versatile disks (DVDs), magnetic tapes, and other optical and non-optical data storage devices. A computer readable medium can also be distributed over a network-coupled computer system so that the computer readable code is stored and executed in a distributed fashion.

Although one or more embodiments of the present invention have been described in some detail for clarity of understanding, certain changes may be made within the scope of the claims. Accordingly, the described embodiments are to be considered as illustrative and not restrictive, and the scope of the claims is not to be limited to details given herein but may be modified within the scope and equivalents of the claims. In the claims, elements and/or steps do not imply any particular order of operation unless explicitly stated in the claims.

Virtualization systems in accordance with the various embodiments may be implemented as hosted embodiments, non-hosted embodiments, or as embodiments that blur distinctions between the two. Furthermore, various virtualization operations may be wholly or partially implemented in hardware. For example, a hardware implementation may employ a look-up table for modification of storage access requests to secure non-disk data.

Many variations, additions, and improvements are possible, regardless of the degree of virtualization. The virtualization software can therefore include components of a host, console, or guest OS that perform virtualization functions.

Plural instances may be provided for components, operations, or structures described herein as a single instance. Boundaries between components, operations, and data stores are somewhat arbitrary, and particular operations are illustrated in the context of specific illustrative configurations. Other allocations of functionality are envisioned and may fall within the scope of the invention. In general, structures and functionalities presented as separate components in exemplary configurations may be implemented as a combined structure or component. Similarly, structures and functionalities presented as a single component may be implemented as separate components. These and other variations, additions, and improvements may fall within the scope of the appended claims.

What is claimed is:

1. A method of selecting a primary instance of a horizontally scaled service executing in a public cloud, comprising:
querying, by a first instance of a plurality of instances of the horizontally scaled service, a database for a value of an identifier of a primary instance, the primary instance configured to perform an exclusive task, each of the plurality of instances other than the primary instance configured to defer the exclusive task to the primary instance;
setting, by the first instance, the value of the identifier of the primary instance to a first identifier of the first instance in response to the value of the identifier of the primary instance being unset in the database; and
updating data associated with the identifier of the primary instance in the database, by the first instance while performing the exclusive task, to the exclusion of each other instance of the plurality of instances.

2. The method of claim 1, further comprising:
querying, by a second instance of the plurality of instances of the service, the database for the value of the identifier of the primary instance; and
functioning, by the second instance, as a secondary instance of the service in response to the value of the identifier of the primary instance being set, each secondary instance of the service excluded from updating the data associated with identifier of the primary instance in the database.

3. The method of claim 1, wherein the database is configured to unset the value of the identifier of the primary instance after a threshold time period during which the first instance does not update the data.

4. The method of claim 3, further comprising:
querying, by a second instance of the plurality of instances of the service, the database for the identifier of the primary instance;
setting, by the second instance, the value of the identifier of the primary instance to a second identifier of the second instance in response to the value of the identifier of the primary instance being unset.

5. The method of claim 4, further comprising:
updating data associated with the identifier of the primary instance in the database, by the second instance, to the exclusion of each other instance of the plurality of instances.

6. The method of claim 1, wherein the data associated with the identifier of the primary instance comprises status data for a task being performed by the horizontally scaled service, and wherein the exclusive task comprises updating the status data.

7. The method of claim 6, wherein the horizontally scaled service comprises an entitlement service configured create the task, the task configured to entitle software in a data center in communication with the public cloud.

8. The method of claim 1, wherein the public cloud is in communication with a data center through a messaging fabric, wherein the horizontally scaled service executing in the public cloud establishes a connection with endpoint software executing in the data center by exchanging messages, over the messaging fabric, with an agent platform appliance, and wherein the exclusive task is to track status of a task sent by the horizontally scaled service to the endpoint software.

9. A non-transitory computer readable medium comprising instructions to be executed in a computing device to cause the computing device to carry out a method of selecting a primary instance of a horizontally scaled service executing in a public cloud, comprising:
querying, by a first instance of a plurality of instances of the horizontally scaled service, a database for a value of an identifier of a primary instance, the primary instance configured to perform an exclusive task, each of the plurality of instances other than the primary instance configured to defer the exclusive task to the primary instance;
setting, by the first instance, the value of the identifier of the primary instance to a first identifier of the first instance in response to the value of the identifier of the primary instance being unset in the database; and
updating data associated with the identifier of the primary instance in the database, by the first instance while performing the exclusive task, to the exclusion of each other instance of the plurality of instances.

10. The non-transitory computer readable medium of claim 9, further comprising:
querying, by a second instance of the plurality of instances of the service, the database for the value of the identifier of the primary instance; and
functioning, by the second instance, as a secondary instance of the service in response to the value of the identifier of the primary instance being set, each secondary instance of the service excluded from updating the data associated with identifier of the primary instance in the database.

11. The non-transitory computer readable medium of claim 9, wherein the database is configured to unset the value of the identifier of the primary instance after a threshold time period during which the first instance does not update the data.

12. The non-transitory computer readable medium of claim 11, further comprising:
querying, by a second instance of the plurality of instances of the service, the database for the identifier of the primary instance;
setting, by the second instance, the value of the identifier of the primary instance to a second identifier of the second instance in response to the value of the identifier of the primary instance being unset.

13. The non-transitory computer readable medium of claim 12, further comprising:
updating data associated with the identifier of the primary instance in the database, by the second instance, to the exclusion of each other instance of the plurality of instances.

14. The non-transitory computer readable medium of claim 9, wherein the public cloud is in communication with a data center through a messaging fabric, wherein the horizontally scaled service executing in the public cloud establishes a connection with endpoint software executing in the data center by exchanging messages, over the messaging fabric, with an agent platform appliance, and wherein the exclusive task is to track status of a task sent by the horizontally scaled service to the endpoint software.

15. A virtualized computing system, comprising:
a public cloud in communication with a data center through a messaging fabric over a public network; and
an entitlement service executing in the public, and an entitlement agent of an agent gateway appliance executing in the data center, the entitlement service configured to entitle endpoint software in the data center, the entitlement service comprising a plurality of instances and configured to select a primary instance of the plurality of instances by:
querying, by a first instance of a plurality of instances of the entitlement service, a database for a value of an identifier of a primary instance, the primary instance configured to perform an exclusive task, each of the plurality of instances other than the primary instance configured to defer the exclusive task to the primary instance;
setting, by the first instance, the value of the identifier of the primary instance to a first identifier of the first instance in response to the value of the identifier of the primary instance being unset in the database; and
updating data associated with the identifier of the primary instance in the database, by the first instance while performing the exclusive task, to the exclusion of each other instance of the plurality of instances.

16. The virtualized computing system of claim 15, further comprising:
querying, by a second instance of the plurality of instances of the service, the database for the value of the identifier of the primary instance; and
functioning, by the second instance, as a secondary instance of the service in response to the value of the identifier of the primary instance being set, each secondary instance of the service excluded from updating the data associated with identifier of the primary instance in the database.

17. The virtualized computing system of claim 15, wherein the database is configured to unset the value of the identifier of the primary instance after a threshold time period during which the first instance does not update the data.

18. The virtualized computing system of claim 17, further comprising:
querying, by a second instance of the plurality of instances of the service, the database for the identifier of the primary instance;
setting, by the second instance, the value of the identifier of the primary instance to a second identifier of the second instance in response to the value of the identifier of the primary instance being unset.

19. The virtualized computing system of claim 18, further comprising:
updating data associated with the identifier of the primary instance in the database, by the second instance, to the exclusion of each other instance of the plurality of instances.

20. The virtualized computing system of claim 15, wherein the data associated with the identifier of the primary instance comprises status data for a task being performed by the entitlement service, and wherein the exclusive task comprises updating the status data.
